(19) United States
(12) Patent Application Publication
(10) Pub. No.: US 2024/0150624 A1
(43) Pub. Date: May 9, 2024

(54) RELEASE LINER AND ADHESIVE SHEET

(71) Applicant: LINTEC Corporation, Tokyo (JP)

(72) Inventors: Takuma OKUBO, Tokyo (JP); Akihito YAMADA, Tokyo (JP)

(73) Assignee: LINTEC Corporation, Tokyo (JP)

(21) Appl. No.: 17/766,603

(22) PCT Filed: Oct. 30, 2020
(86) PCT No.: PCT/JP2020/040855

§ 371 Date: Jan. 17, 2024

(30) Foreign Application Priority Data
Oct. 31, 2019 (WO) PCT/JP2019/042875

(51) Int. Cl. C09J 7/40

(52) U.S. Cl. CPC C09J 7/403

(57) ABSTRACT

[Problem] A release liner and an adhesive sheet with which contact area of an adhesive layer on an adherend is reduced at positioning and adhesive force can excellently develop at the adhesive layer after positioning are provided.

[Solution] A release liner 100 has a surface 101 at which concave portions 120 are formed. The concave portion narrows toward a deepest part 121, and a portion 110 between the concave portions has a convex sectional shape in a thickness direction D1 of the release liner. The convex sectional shape narrows at a continuous tilt from the deepest part to an apex 111 of the convex sectional shape, and in the convex sectional shape, a width w at a height of ½h, which is half of a height h, and the height h have a relation of w>h.

### TECHNICAL FIELD

The present invention relates to a release liner and an adhesive sheet.

### BACKGROUND ART

Conventionally, a minute emboss pattern has been formed on a surface of an adhesive layer to provide an adhesive sheet with a function such as bulge prevention, and for example, Patent Literature 1 discloses formation of minute protrusions on a surface of an adhesive layer, and Patent Literature 2 discloses formation of groove-shaped valley portions on an adhesive layer.

The minute protrusions formed on the surface of the adhesive layer in the adhesive sheet in Patent Literature 1 and the groove-shaped valley portions formed at the adhesive layer in the adhesive sheet in Patent Literature 2 disappear with time after the adhesive sheet is attached to an adherend, and strong adhesive force to an adherend develops along with increase of contact area of the adhesive layer on an adherend. Patent Literature 1 discloses an example in which the minute protrusions on the adhesive layer disappeared in one day after attaching.

### CITATION LIST

### Patent Literature

Patent Literature 1: JP 2010-83915 A
Patent Literature 2: JP 2004-75845 A

### SUMMARY OF INVENTION

### Technical Problem

However, when such a long duration of one day is needed until strong adhesive force develops as in Patent Literature 1 described above, a position of the adhesive sheet potentially shifts during the duration. Thus, in actual attaching work, strong adhesive force preferably develops as soon as possible after the adhesive sheet is positioned to a predetermined position.

On the other hand, in the adhesive sheet of Patent Literature 2 described above, the width of each valley portion formed at the adhesive layer is small and a convex body that contacts an adherend is formed with a large width in the adhesive layer, and thus the adhesive sheet is immediately attached to an adherend but is difficult to be attached again, which makes positioning difficult.

Accordingly, the present invention is intended to provide a release liner and an adhesive sheet with which contact area of an adhesive layer on an adherend is reduced at positioning and adhesive force can excellently develop at the adhesive layer after positioning.

### Solution to Problem

A release liner of the present invention for achieving the above object has a surface at which concave portions are formed. The concave portion narrows toward a deepest part, and a portion between the concave portions has a convex sectional shape in a thickness direction of the release liner. The convex sectional shape narrows at a continuous tilt from the deepest part to an apex of the convex sectional shape, and in the convex sectional shape, a width w at a height of ½h, which is half of a height h, and the height h have a relation of w>h.

An adhesive sheet of the present invention for achieving the above object includes the release liner, an adhesive layer disposed on the surface of the release liner, and a substrate layer in this order in a laminating direction.

### Advantageous Effects of Invention

According to the invention configured as described above, the shape of the release liner is transferred in an inverted manner to an adhesive layer of an adhesive sheet, and as a result, convex portions that contact an adherend are formed and a gap with a relatively large width is formed between the convex portions, and accordingly, ratio of the convex portions that contact an adherend is relatively reduced. With this configuration, contact area of the adhesive layer on an adherend is reduced at positioning.

Moreover, according to the invention configured as described above, the adhesive layer is likely to be settled to and closely contact a surface of an adherend at attaching after positioning, and thus adhesive force can excellently develop at the adhesive layer.

### BRIEF DESCRIPTION OF DRAWINGS

FIG. 1 is a perspective view showing a release liner of an embodiment.

FIG. 2 is aside view (cross-sectional view in a thickness direction) of the release liner of the embodiment when viewed from reference sign 2 in FIG. 1.

FIG. 3 is a side view showing an adhesive sheet of the embodiment.

FIG. 4 is a side view showing the adhesive sheet of the embodiment from which the release liner is removed.

FIG. 5 is a perspective view of the adhesive sheet of the embodiment from which the release liner is removed when viewed from an adhesive layer side.

FIG. 6 is a diagram showing an adhesive sheet of Comparative Example 1 in contact with an adherend.

FIG. 7 is a diagram showing the adhesive sheet of the embodiment in contact with an adherend.

FIG. 8 is a diagram showing an adhesive sheet of Comparative Example 2 in contact with an adherend.

FIG. 9 is a perspective view showing a release liner of a modification.

FIG. 10 is across-sectional view showing a release liner of another modification.

### DESCRIPTION OF EMBODIMENTS

Hereinafter, an embodiment of the present invention will be described with reference to the accompanying drawings. Note that a scale ratio in the drawings is exaggerated for the convenience of explanation, and is different from the actual ratio.

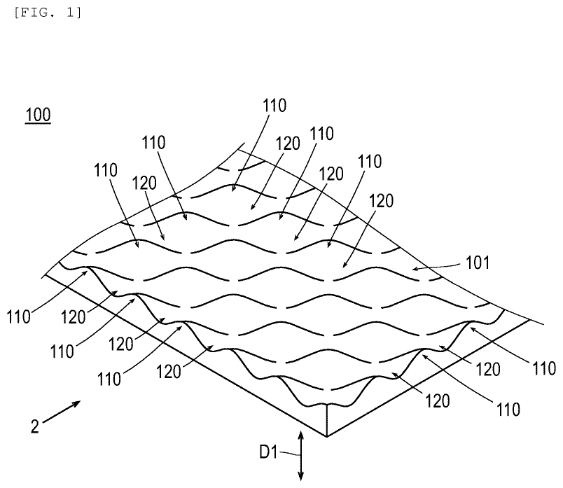

As shown in FIG. 1, a release liner 100 of the embodiment has a surface 101 at which a convex portion 110 and a concave portion 120 are alternately formed. Convex portions 110 are dotted as islands at the surface 101. Concave portions 120 are also formed as dotted at the surface 101. The surface 101 may be coated with a release agent such as silicone.

The release liner 100 is formed of, for example, paper or a resin film but what kind of material the release liner is formed of is not particularly limited. The release liner 100 has a single-layer structure in the example shown in the figure but may have a laminated structure in which layers are laminated. Such a laminated structure is, for example, a laminated structure in which a covering layer formed of thermoplastic resin such as polyethylene (PE) is laminated on the surface of a paper substrate formed of high-quality paper, glassine paper, kraft paper, or the like, or on the surface of a resin layer formed of polyethylene terephthalate (PET) or the like, but is not limited thereto.

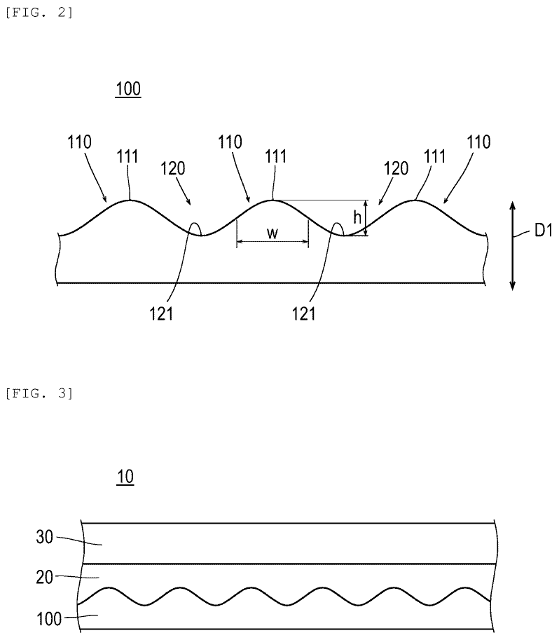

As shown in FIG. 2, the concave portion 120 narrows toward a deepest part 121. The deepest part 121 preferably has a shape that curves with a tilt continuously changing but is not limited thereto and may have, for example, a planate shape.

In the present embodiment, a portion between the concave portions 120 forms a convex portion 110 protruding in a thickness direction D1 and has a convex sectional shape. The convex sectional shape narrows at a continuous tilt from the deepest part 121 of the concave portion 120 to an apex 111 of the convex sectional shape. In the convex sectional shape, a height h (the distance between the deepest part 121 and the apex 111 in the thickness direction D1) and a width w at a height of ½h, which is half of the height h, have a relation of w>h. The apex 111 of the convex portion 110 (convex sectional shape) has a shape that curves with a tilt continuously changing.

The height h of the convex sectional shape is not particularly limited but is, for example, 4 μm or more 50 μm or less approximately, preferably 5 μm or more 15 μm or less. The width w is preferably 15 μm or more 400 μm or less but is not limited thereto.

The interval between the convex portions 110 in a plane direction orthogonal to the thickness direction D1 and the interval between the concave portions 120 in the plane direction are not particularly limited but are each, for example, 30 μm or more 800 μm or less approximately, preferably 50 μm or more 500 μm or less.

The convex portions 110 and the concave portions 120 are formed by, for example, emboss fabrication, but how they are formed is not particularly limited. In the emboss fabrication, for example, a roller or a mold having, on its surface, shapes in which the convex portions 110 and the concave portions 120 are inverted are pressed against a sheet-like liner material having a flat surface, thereby forming the convex portions 110 and the concave portions 120. Minute shapes on the surface of the roller or the mold used in the emboss fabrication are formed by, for example, etching, but the formation is not limited thereto and the minute shapes may be formed on the surface of the roller or the mold by another method.

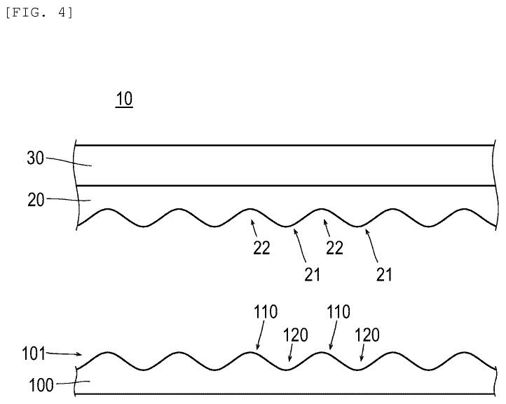

As shown in FIG. 3, the release liner 100 together with an adhesive layer 20 and a substrate layer 30 is laminated in this order, thereby constituting an adhesive sheet 10.

The adhesive sheet 10 is used for, for example, an advertisement or a decoration attached to an adherend such as an automobile, a two-wheeled vehicle, a train, a truck, an outdoor sign, an outdoor advertisement, a shop window, or a wall but may be applied to other usage than advertisement and decoration and what kind of adherend the adhesive sheet is attached to is not particularly limited. Moreover, a shape of the adhesive sheet 10 is not particularly limited and may be, for example, a rectangular shape such as a paper sheet, an elongated shape, or a shape in accordance with a shape of an adherend.

The adhesive sheet 10 is formed by, for example, applying an adhesive to the release liner 100 to form the adhesive layer 20 and thereafter attaching the substrate layer 30 to the adhesive layer 20 by pressing with, for example, a roller or the like, but the formation is not limited thereto.

The adhesive layer 20 is formed of, for example, an acrylic-based adhesive, a rubber-based adhesive, a silicone-based adhesive, a urethane-based adhesive, or a styrene-based block copolymer adhesive, or the like, but is not particularly limited, and these adhesives may be used alone or in a combination of two or more kinds thereof.

The substrate layer 30 can be variously designed in accordance with usage of the adhesive sheet 10. For example, when the adhesive sheet 10 is a decoration sheet to be attached to an adherend such as an automobile, the substrate layer 30 has a laminated structure in which, for example, a support layer made of resin, a decoration layer having decoration in color, pattern, or the like, and a transparent protective layer are laminated in this order, but is not limited thereto and, for example, a configuration in which the substrate layer 30 is formed as a single resin layer is also included in the scope of the present invention. In addition, a configuration in which the constituent material of the substrate layer 30 is a paper substrate is included in the scope of the present invention.

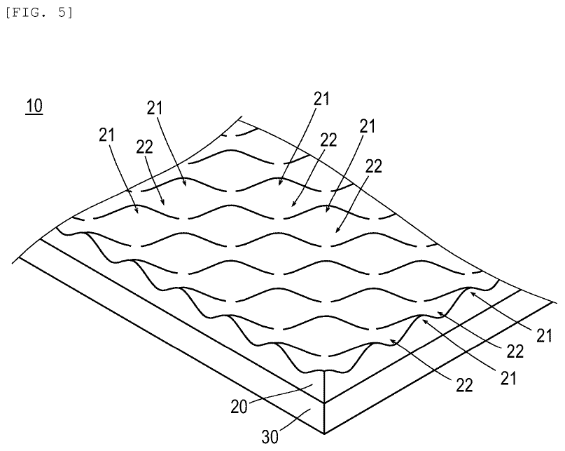

As shown in FIG. 4, the adhesive sheet 10 is used with the release liner 100 removed and is attached to an adherend through the adhesive layer 20.

The adhesive layer 20 has a shape to which the shape of the surface 101 of the release liner 100 is transferred in an inverted manner by being disposed on the surface 101, and alternately includes a convex portion 21 to which the concave portion 120 of the release liner 100 is transferred in an inverted manner and a concave portion 22 to which the convex portion 110 of the release liner 100 is transferred in an inverted manner.

As shown in FIG. 5, the convex portions 21 and the concave portions 22 are formed at the entire surface of the adhesive layer 20. The convex portions 21 are dotted as islands. Since there is a gap between the convex portions 21, air interposed between the adhesive layer 20 and an adherend is discharged through the gap between the convex portions 21, thereby preventing bulge of the adhesive sheet 10.

When lightly contacting an adherend, the adhesive layer 20 contacts an adherend at apexes of the convex portions 21 and is prevented from contacting an adherend at the concave portions 22, and accordingly, contact area of the adhesive layer 20 on an adherend is reduced and the adhesive layer 20 exerts weak adhesive force to an adherend. Thus, the adhesive sheet 10 has slidable capability (slidability) when the adhesive layer 20 lightly contacts an adherend.

Next, the working effects of the present embodiment will be described.

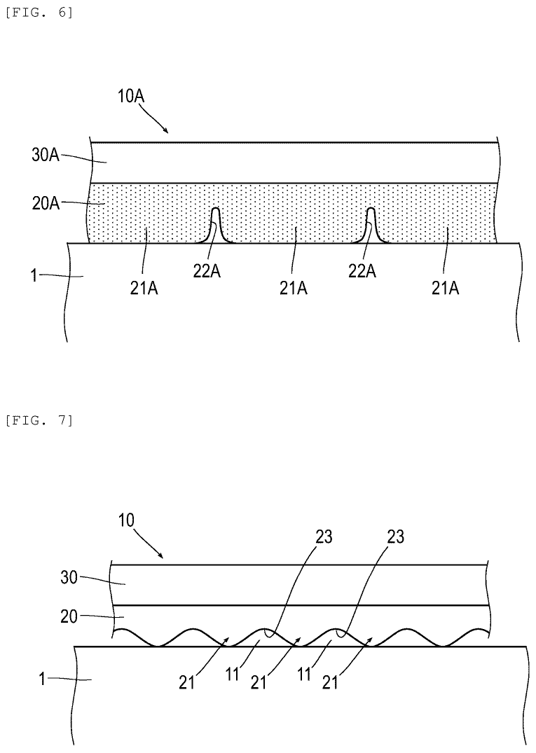

As shown in FIG. 6, in an adhesive sheet 10A of Comparative Example 1 having a configuration same as that disclosed in Patent Literature 2 described above, the width of a valley portion 22A formed at an adhesive layer 20A is reduced, and accordingly, a convex body 21A that contacts an adherend 1 is formed with a large width in the adhesive layer 20A. With this configuration, the adhesive sheet 10A of Comparative Example 1 is immediately attached to an adherend 1, and it is difficult to change a position of the adhesive sheet 10A by sliding or attach the adhesive sheet 10A again, and thus positioning to a desired position is difficult.

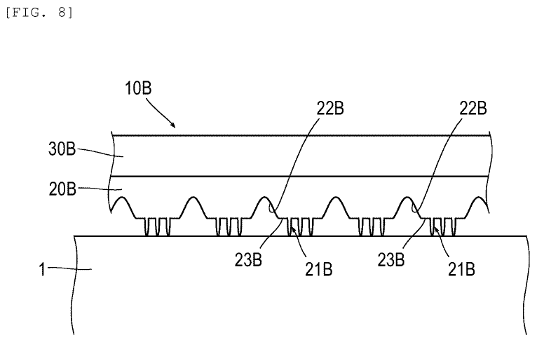

On the other hand, according to the present embodiment as shown in FIG. 7, the shape of the release liner 100 is transferred in an inverted manner to the adhesive layer 20, and accordingly, contact area of the adhesive layer 20 on an adherend 1 is reduced.

Concretely, in the adhesive layer 20, the convex portions 21 to which the concave portions 120 of the release liner 100 are transferred in an inverted manner are formed, and a gap 11 is formed between the convex portions 21, corresponding to the convex sectional shape (convex portion 110) between the concave portions 120 of the release liner 100, and in the present embodiment, since the convex sectional shape is formed with a relatively large width (the width w>the height h), accordingly, the gap 11 is also formed with a relatively large width, and as a result, ratio of the convex portions 21 contacting an adherend 1 is relatively reduced. Therefore, according to the present embodiment, contact area of the adhesive layer 20 on an adherend 1 can be reduced, it is easy to change a position of the adhesive sheet 10 by sliding or attach the adhesive sheet 10 again, and positioning is easy.

After positioning, a worker attaches the adhesive sheet 10 to an adherend 1 by pressing. Along with the attaching of the adhesive sheet 10 to an adherend 1, the convex portions 21 and the gaps 11 disappear and the adhesive layer 20 is flattened and closely contacts an adherend 1.

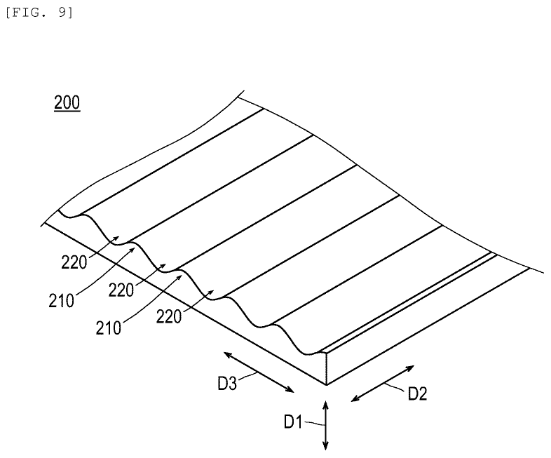

As shown in FIG. 8, in an adhesive sheet 10B of Comparative Example 2 having a configuration same as that disclosed in Patent Literature 1 described above, a minute protrusion 21B is formed at an adhesive layer 20B, and accordingly, contact area of the adhesive layer 20B on an adherend 1 is reduced at positioning, but it is difficult to immediately develop strong adhesive force after positioning with the surface shape of the adhesive layer 20B of Comparative Example 2.

Concretely, in the adhesive sheet 10B of Comparative Example 2, concave portions 22B, a broadly expanding plane 23B separated from an adherend 1, and a large number of minute protrusions 21 independently separated from each other are formed at the adhesive layer 20B, and with these components, a large number of gaps are formed between an adherend 1 and the adhesive layer 20B, and accordingly, at attaching after positioning, it takes time until the adhesive layer 20B is settled to and closely contacts a surface of an adherend 1, and it is difficult to develop strong adhesive force.

On the other hand, in the present embodiment, the concave portions 120 are formed in the release liner 100, and the convex sectional shape of the portion (convex portion 110) between the concave portions 120, which narrows at a continuous tilt from the deepest part 121 of the concave portion 120 to the apex 111, is transferred in an inverted manner to the adhesive layer 20, and as a result, the adhesive layer 20 narrows at a continuous tilt from the apex of the convex portion 21 to a part 23 continuous therewith and most separated from an adherend 1 as shown in FIG. 7. With this configuration, in the present embodiment, the broadly expanding plane 23B separated from an adherend 1 and the large number of minute protrusions 21B each independently protruding at the plane 23B in the adhesive sheet 10B of Comparative Example 2 are not formed, and formation of a large number of gaps between an adherend 1 and the adhesive layer 20 is prevented unlike Comparative Example 2.

Thus, according to the present embodiment, at attaching after positioning, the adhesive layer 20 is likely to be settled to and closely contact a surface of an adherend 1, and adhesive force excellently develops.

In addition, in the present embodiment, since the concave portions 120 are formed as dotted at the surface 101 of the release liner 100 and such a shape is transferred in an inverted manner to the adhesive layer 20, the convex portions 21 are formed as dotted like islands at the adhesive layer 20 as shown in FIG. 5. Accordingly, contact area of the adhesive layer 20 on an adherend 1 when the adhesive layer 20 lightly contacts an adherend 1 is effectively reduced, and thus it is easier to change the position of the adhesive sheet 10 by sliding or attach the adhesive sheet 10 again, which increases easiness of positioning.

The present invention is not limited to the above-described embodiment, and can be variously modified within the scope of the claims.

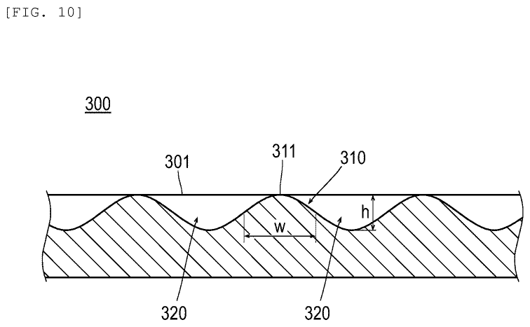

For example, as shown in FIG. 9, a release liner 200 including groove-shaped concave portions 220 is also included in the scope of the present invention.

A portion between the concave portions 220 forms a linearly extending ridge portion 210. The ridge portion 210 protrudes in the thickness direction D1 and extends in a plane direction D2 orthogonal to the thickness direction D1 until the ridge portion 210 reaches an edge of the release liner 200.

In a plane direction D3 orthogonal to the plane direction D2, the ridge portion 210 has a sectional shape same as that of the convex portion 110 of the above-described embodiment shown in FIG. 2. In the plane direction D3, the concave portion 220 has a sectional shape same as that of the concave portion 120 of the above-described embodiment shown in FIG. 2.

According to the release liner 200 of a modification, the ridge portions 210 are transferred in an inverted manner to an adhesive layer of an adhesive sheet, and as a result, linear grooves reaching an edge of the adhesive layer are formed at the adhesive layer. When attached to an adherend, the adhesive sheet smoothly discharges, through the grooves, air interposed between an adherend and the adhesive layer and thus can be more effectively prevented from bulging.

In the release liner 200 of the modification, the ridge portions 210 and the concave portions 220 extend straight in the plane direction D2 but are not limited to such a configuration and may extend with curves. In addition, the scope of the present invention also includes a release liner in which other ridge portions and concave portions extending in the plane direction D3 are formed in addition to the ridge portions 210 and the concave portions 220 extending in the plane direction D2. In such a configuration, the ridge portions are formed with intersections.

Although the convex portions 110 in the release liner 100 of the above-described embodiment and the ridge portions 210 in the release liner 200 of the above-described modification protrude in the thickness direction D1, the present invention is not limited to such a configuration in which a portion between concave portions is formed as a protrusion.

For example, in a release liner 300 of another modification shown in FIG. 10, concave portions 320 are formed as dotted, and a portion 310 between the concave portions 320 has a convex sectional shape that satisfies the relation of the width w>the height h as in the above-described embodiment shown in FIG. 2, but does not protrude from a surface 301 of the release liner 300. In this configuration, for example, an apex 311 of the convex sectional shape forms an edge of an opening part of the concave portion 320.

The present application is based on International Application No. PCT/JP2019/042875, filed on Oct. 31, 2019, the entire contents of which are incorporated herein by reference.

### REFERENCE SIGNS LIST

1: adherend
10: adhesive sheet
20: adhesive layer
21: convex portion
22: concave portion
30: substrate layer
10A, 10B: adhesive sheet of comparative example
20A, 20B: adhesive layer
30A, 30B: substrate layer
100: release liner
101: surface of the release liner
110: convex portion (portion between concave portions)
111: apex of the convex portion (apex of a convex sectional shape)
120: concave portion
121: deepest part
200: release liner
210: ridge portion (portion between concave portions)
220: concave portion
300: release liner
301: surface of the release liner
310: portion between concave portions
320: concave portion
D1: thickness direction
D2, D3: plane direction
h: height
w: width

1. A release liner having a surface at which concave portions are formed, wherein
the concave portion narrows toward a deepest part,
a portion between the concave portions has a convex sectional shape in a thickness direction of the release liner,
the convex sectional shape narrows at a continuous tilt from the deepest part to an apex of the convex sectional shape, and
in the convex sectional shape, a width w at a height of ½h, which is half of a height h, and the height h have a relation of w>h.

2. The release liner according to claim 1, wherein the concave portions are formed as dotted at the surface.

3. The release liner according to claim 1, wherein the portion between the concave portions protrudes in the thickness direction and forms a ridge portion linearly extending in a plane direction and reaching an edge of the release liner.

4. An adhesive sheet comprising the release liner according to anyone of claims 1 to 3, an adhesive layer disposed on the surface of the release liner, and a substrate layer in this order in a laminating direction.
